(19) United States
(12) Patent Application Publication
(10) Pub. No.: US 2020/0180355 A1
(43) Pub. Date: Jun. 11, 2020

(54) YARN DRAWING TOOL AND TRACING BOARD

(71) Applicant: Kahootz, LLC, Ann Arbor, MI (US)

(72) Inventors: Brent Oeschger, Ann Arbor, MI (US); Laura Morrison, Livonia, MI (US); Alanis McNier, Detroit, MI (US)

(21) Appl. No.: 16/707,569

(22) Filed: Dec. 9, 2019

Related U.S. Application Data
(60) Provisional application No. 62/777,412, filed on Dec. 10, 2018.

(51) Int. Cl. B44F 3/00; B44F 11/00; B44C 1/00; B65H 55/00

(52) U.S. Cl. CPC B44F 3/00; B44F 11/00; B65H 2701/31; B65H 55/00; B44C 1/00

(57) ABSTRACT

A tracing board assembly includes a transparent sheet having a first surface and a second surface. The first surface including a plurality of hooks providing hook-and-loop adhesion. A frame may be secured to a perimeter of the transparent sheet. An original image abuts the second surface of the transparent sheet and visible through the transparent sheet. The original image may include alphanumeric characters corresponding to colors of yarn. A pen having a tubular body has yarn extending through the tubular body. The pen can be used to adhere the yarn to selected areas of the transparent sheet using the original image as a guide.

### CROSS-REFERENCED TO RELATED APPLICATION

This application claims priority to U.S. Provisional Application No. 62/777,412, which was filed on Dec. 10, 2018.

### BACKGROUND

This disclosure relates to a drawing tool and tracing board.

Known visual art supplies include paper and implements for making marks on paper, such as ink markers, pens, graphite pencils, crayons, or paintbrushes. These examples make permanent marks on paper.

Tracing tools exist to allow artists to make accurate copies of portions of an image. Some example tracing tools include graphite copy paper and backlit tracing boards that can shine light through multiple sheets of thin paper.

### SUMMARY

This disclosure relates to equipment for producing visual yarn art.

A tracing board includes a transparent adhesive sheet. The adhesive sheet includes an adhesive surface covered in hooks that extend from the surface providing hook and loop adhesion. The sheet may be placed over an original image, which is visible through the sheet. The tracing board optionally includes a frame holding the transparent adhesive sheet on a flat plane.

An exemplary method for creating yarn art includes providing a yarn pen, which may have a generally tubular body portion. The method further includes inserting a free end of the yarn in a proximal end of the pen, and pushing the free end through the pen until it extends from a distal end of the pen. The original image may be used as a guide by passing the distal end of the pen across an adhesive side of the adhesive sheet opposite from the original image such that the yarn attaches to the adhesive sheet to produce a copy, yarn image.

According to an alternative embodiment, a pen includes a spool, a proximal end, and a distal end. A pen axis extends from a center of a proximal opening in the proximal end to a center of a distal opening in the distal end. A channel extends continuously between the proximal opening and distal opening. The proximal end includes a shoulder, and a post extends from the shoulder in a direction parallel to the pen axis. The spool rotates about the post.

The pen further comprises a separable proximal piece and distal piece. The proximal piece includes the proximal end, and the distal piece includes the distal end. The post is separable from the shoulder, and the spool is slidably removable from the post when the post is separated from the shoulder.

These and other features may be best understood from the following drawings and specification.

### BRIEF DESCRIPTION OF THE DRAWINGS

The drawings can be briefly described as follows:

FIG. 1 shows a yarn pen according to a first embodiment.

FIG. 2A shows the yarn pen of FIG. 1 disassembled into separate components.

FIG. 2B shows a cross section of the yarn pen of FIG. 1.

FIG. 3 shows a tracing board.

FIG. 4 is a cross-sectional view of an adhesive sheet and backing of the tracing board of FIG. 3.

FIG. 5 shows a yarn pen according to a second embodiment.

FIG. 6 schematically represents a method of using the yarn pen with the tracing board.

### DETAILED DESCRIPTION

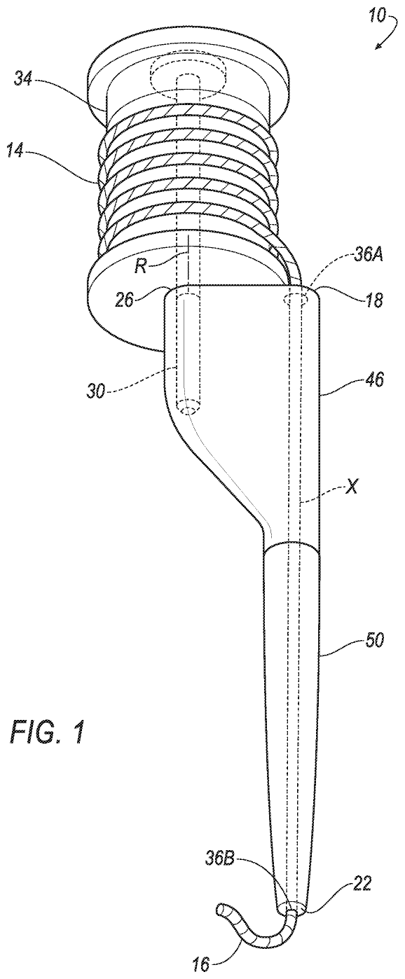

FIG. 1 illustrates a pen 10 for drawing with yarn 14 according to a first embodiment. The pen 10 includes a tubular body 12 having a proximal end 18 and a distal end 22. The proximal end 18 and distal end 22 have a proximal opening 36A and distal opening 36B, respectively. A pen axis X extends through the tubular body 12 between a center of the proximal opening 36A and distal opening 36B.

The tubular body 12 may be formed of a proximal piece 46 and a distal piece 50, respectively including the proximal end 18 and distal end 22. The distal piece 50 as illustrated has a narrow diameter so as to be comfortably gripped like a conventional pen, while the proximal piece 46 has a wider dimension. In an alternative embodiment, the proximal piece 46 could instead have a similar narrow diameter. Alternatively, the proximal piece 46 and the distal piece 50 could be one integrally formed piece (plastic or other suitable material).

The proximal piece 46 further includes a shoulder 26, and a post 30 extends from the shoulder 26 generally parallel to the pen axis X. A spool 34 is rotatably disposed on the post 30, and is therefore able to rotate about a spool axis R that is generally parallel to, but offset from, not collinear with, the pen axis X.

Yarn 14 is wound around the spool 34. The yarn 14 has a free end 16 that can be inserted into the proximal opening 36A and drawn out of the distal opening 36B as shown. As the free end 16 of the yarn 14 is pulled, the spool 34 rotates to allow the yarn 14 to unwind, in turn allowing the free end 16 to extend further.

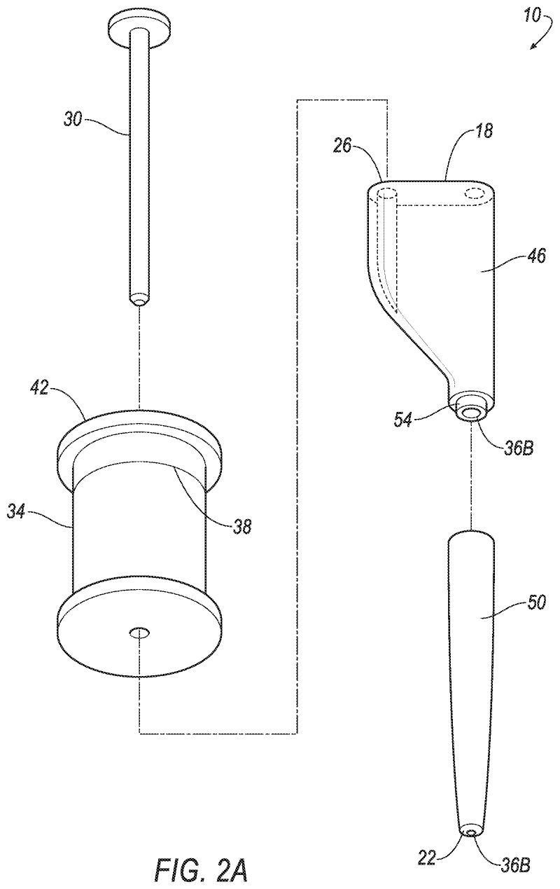

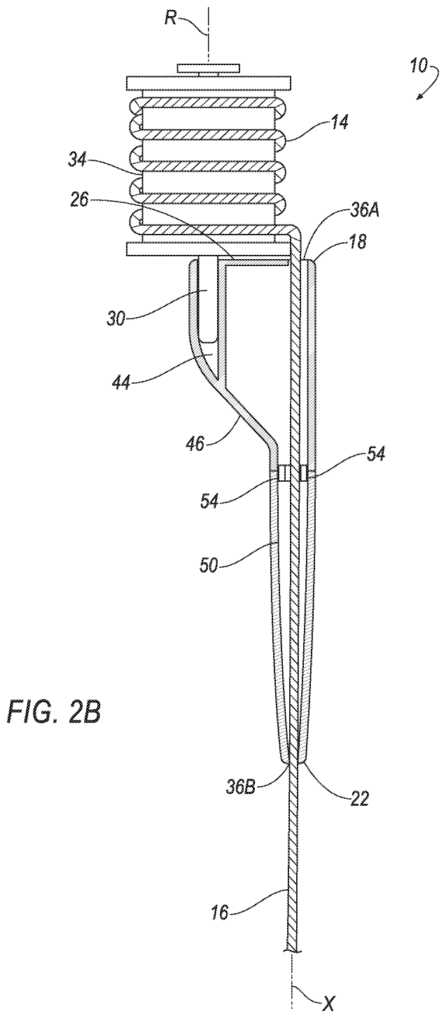

In FIG. 2A, the pen 10 according to the illustrated embodiment is shown disassembled. FIG. 2B is a section view of the assembled pen 10. When the pen 10 is assembled, the post 30 is inserted into a post hole 44 on the shoulder 26. The post hole 44 may have a slight interference fit with the post 30 for secure assembly. For example, the post hole 44 can be tapered to a point so the post 30 will achieve an interference fit when wedged into a tapering portion of the post hole 44.

When disassembled as shown in FIG. 2A, the post is separated from the shoulder 26, and the spool 34 can freely slide off the post 30. The spool 34 may additionally include a seam 38 such that a separable cap 42 can be removed from the spool 34 to aid with winding or removing yarn 14 on the spool 34.

The separable parts of the pen 10 according to the illustrated embodiment further include the proximal piece 46 and distal piece 50. The proximal piece 46 further includes a peg 54 for connecting the distal piece 50 and the proximal piece 46. The peg 54 may have at least one of a spline fit and an interference fit with an opening on the distal piece 40. Further, the peg 54 has a peg opening 36. As shown, the proximal piece 18 and distal piece 22 are at least partially hollow and thereby provide a continuous channel extending through the proximal opening 36A, peg opening 36C, and distal opening 36B.

The illustrated embodiment of the pen 10 is separable into multiple parts, but a pen 10 with a unitary body is also contemplated. For example, the proximal piece 46 and distal piece 50 could be an inseparable, unitary body. The post 30 could also be formed integrally with or permanently secured to the proximal piece 46.

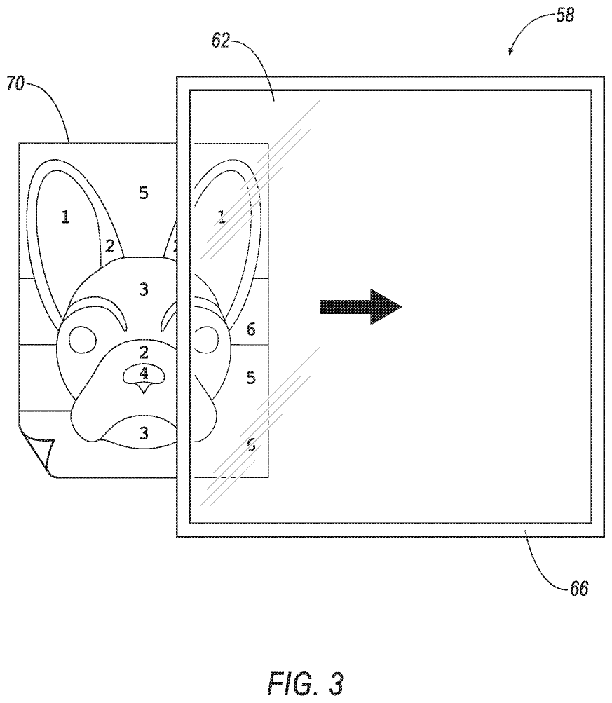

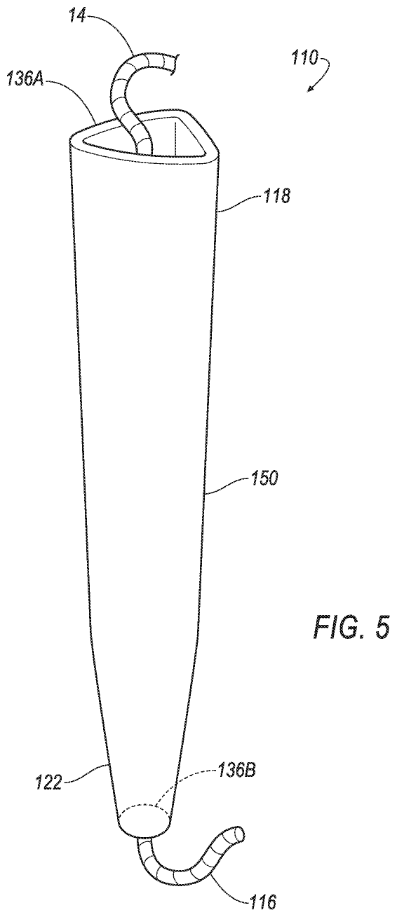

FIG. 3 shows a tracing board 58 that can optionally be used with the pen 10. The tracing board 58 according to the illustrated embodiment includes a transparent adhesive sheet 62. The tracing board 58 is shown with an optional frame 66 that holds the adhesive sheet 62 on a flat plane. Optionally, the tracing board 58 does not include a frame 66. A backing 70, such as paper or cardboard, has an original image, such as a picture or black-and-white line drawing, printed on an upper surface. The backing 70 can be placed behind the tracing board 58. The original image on the backing 70 would be visible through the adhesive sheet 62 as shown, for example, in FIG. 5. The original image on the backing 70 may include alphanumeric characters in each area of the image indicating one recommendation as to which color yarn should be secured over which areas of the image. As used herein, the term “transparent” does not have to be 100% transparent, but simply means sufficiently transparent so that one can see the original image sufficiently to use it as a guide for placing the yarn.

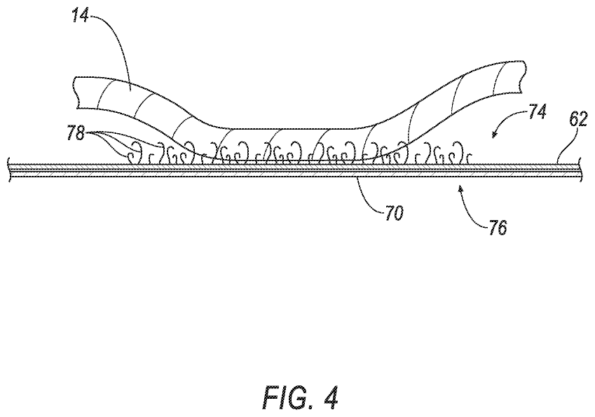

FIG. 4 is an enlarged, cross-sectional view of a portion of the adhesive sheet 62 and backing 70 of FIG. 3. The adhesive sheet 62 has an adhesive side 74. According to the illustrated embodiment, the adhesive side 74 is covered in hooks 78. The hooks 78 are suitable for Velcro-style hook-and-loop attachment to certain surfaces and fabrics, which provides adhesion for the adhesive sheet 62. For example, the yarn 14 can be hooked or tangled on the hooks 78, meaning yarn 14 can be removably but securely drawn across the adhesive side 74 of the adhesive sheet 62.

Further, the backing 70 can be secured to the adhesive sheet 62. For example, the backing 70 can be secured to a reverse side 76 of the adhesive sheet 62 with adhesive. Alternatively, the original image can be printed directly on the adhesive sheet 62, without the backing, although the backing 70 may still be used for structural support.

FIG. 5 illustrates a yarn pen 110 according to another exemplary embodiment. The pen 110 according to the embodiment of FIG. 5 includes a unitary tubular body 150 with a proximal end 118 and distal end 122, which respectively have a proximal opening 136A and distal opening 136B. Yarn 14 from any source can be fed directly through the proximal opening 136A to the distal opening 136B such that the free end 16 of the yarn 14 extends from the distal opening 136B. The body 150 is elongated along a pen axis and is tubular (as used herein “tubular” is not limited to a round cross-section, but could have any hollow cross section, as shown).

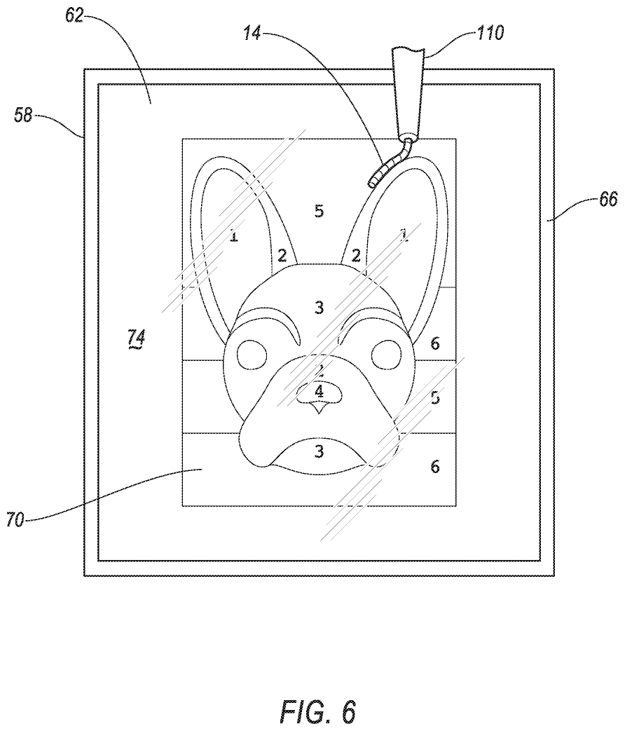

FIG. 6 shows the pen 110 in use with the tracing board 58. The backing 70 is placed behind the tracing board 58 so that original image is visible through the adhesive sheet 62. The adhesive side 74 faces away from the original image. The pen 110 is passed across the tracing board 58 such that the yarn 14 adheres to the adhesive sheet 62 to draw out a copy yarn image 82. The user moves the pen 10 across the sheet 62 and traces the original image and/or fills in the areas of the original image with different colors of yarn 14. Optionally, the colors of yarn are associated with the alphanumeric characters on the original image 70. Alternatively, the pen 10 of the first embodiment could also be used with the tracing board 58.

Although examples above have the specific components shown in the illustrations, embodiments of this disclosure are not limited to those particular combinations. It is possible to use some of the components or features from one of the examples in combination with features or components from another one of the examples.

Further, all illustrated proportions and relative directions are merely exemplary, and variations to each are contemplated. For example, any two elements illustrated and described above as perpendicular to one another may in practice be only approximately or generally perpendicular to one another.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A tracing board assembly comprising:
a transparent sheet having a first surface and a second surface; and
the first surface including a plurality of hooks providing hook-and-loop adhesion.

2. The assembly of claim 1 further including an original image abutting the second surface of the transparent sheet and visible through the transparent sheet.

3. The assembly of claim 2 further including a pen, the pen including a tubular body.

4. The assembly of claim 3 further including yarn extending through the tubular body.

5. The assembly of claim 4 wherein the original image includes alphanumeric characters in different areas of the original image, wherein the alphanumeric characters correspond to different colors of yarn.

6. The assembly of claim 5 further including a frame secured to a perimeter of the transparent sheet.

7. The assembly of claim 2 further including a frame secured to a perimeter of the transparent sheet.

8. The assembly of claim 2 wherein the original image includes alphanumeric characters in different areas of the original image, wherein the alphanumeric characters correspond to different colors of yarn.

9. The assembly of claim 8 further including a frame secured to a perimeter of the transparent sheet.

10. A method for making art including the steps of:
a) securing a first portion of yarn to at least one hook of a plurality of hooks formed on a first surface of a sheet disposed over an original image, wherein the original image is visible through the sheet; and
b) using the original image as a guide, securing additional portions of the yarn to other ones of the plurality of hooks to form a yarn image.

11. The method of claim 10 further including the steps of:
c) prior to said step a), passing a free end of the yarn through a proximal end of a tubular pen body until it extends from an opposite distal end of the tubular pen body; and
during said step b), passing the distal end of the pen across the first surface of the sheet to secure the additional portions of the yarn thereto to produce the yarn image

12. The method of claim 10 wherein the original image includes alphanumeric characters in different areas of the original image, wherein the alphanumeric characters each correspond to a different color, and wherein said method further includes the step of repeating said step b) for each of the different areas of the original image with a corresponding color portions of yarn.

13. A drawing tool comprising
a body portion having a proximal end and a distal end, a pen axis extending from a center of a proximal opening in the proximal end to a center of a distal opening in the distal end, wherein the proximal end includes a shoulder;
a post extending from the shoulder in a direction generally parallel to the pen axis;
a spool rotatably mounted to the post.

14. The drawing tool of claim 13 further including yarn wrapped around the spool.

15. The drawing tool of claim 13 wherein the yarn extends into the proximal opening and out of the distal opening.
